(19) United States
(12) Patent Application Publication
(10) Pub. No.: US 2020/0160186 A1
(43) Pub. Date: May 21, 2020

(54) INFERENCE SYSTEM

(71) Applicant: Cirrus Logic International Semiconductor Ltd., Edinburgh (GB)

(72) Inventors: John Paul LESSO, Edinburgh (GB); John Laurence PENNOCK, Edinburgh (GB); Gordon James BATES, Edinburgh (GB)

(73) Assignee: Cirrus Logic International Semiconductor Ltd., Edinburgh (GB)

(21) Appl. No.: 16/686,732

(22) Filed: Nov. 18, 2019

Related U.S. Application Data
(60) Provisional application No. 62/769,628, filed on Nov. 20, 2018.

(30) Foreign Application Priority Data
Aug. 29, 2019 (GB) 1912409.8

(51) Int. Cl. G06N 3/08; G06N 5/04

(52) U.S. Cl. CPC G06N 3/082; G06N 5/046

(57) ABSTRACT

There is described an inference system for performing inference in a machine learning or neural net system, preferably an analog computing system. The overall power consumption of the inference system is reduced by providing for a dynamic or adjustable memory refresh rate of the inference system, and/or providing a dynamic or adjustable accuracy level of components of the inference system.

### BACKGROUND

The present invention relates to an inference system for a neural net or machine learning inference process.

Data processing in systems utilising neural nets or machine learning generally involves two separate stages. The first is a learning or training stage, where training data is supplied to a layer of an artificial neural network, and individual neurons of the neural network assign weightings to their inputs based on the task being performed. By comparing the resultant outputs with the known training data set, and repeating over a series of iterations, the neural network learns what are the optimum weighting factor values to apply to the inputs. The training stage requires considerable computing resources to accurately determine the best weights to use for the task being performed.

Once the optimum weights are learned and the network is said to be trained, the second stage is inference, wherein the learned weights are supplied together with an inference engine or system, which is subsequently arranged to receive operational data and for the constituent neurons to apply the programmed weights to their data inputs and provide the system outputs.

Traditionally such learning and inference stages have been performed by centralised servers or “in the cloud”, receiving inputs from and providing resultant outputs to so-called “edge” devices, e.g. mobile phones, tablet computers, “smart” devices, etc. However, increasingly there is a drive to provide neural nets for inference locally in such devices, which may receive trained weights from training processes performed remotely.

In addition, inference systems are increasingly intended for use in always-on applications, e.g. always-on audio monitoring or image processing systems.

As a result, there is a desire to provide inference systems which have reduced power consumption.

### SUMMARY

Accordingly, there is provided an inference system comprising:
at least one neuron circuit arranged to receive at least one data input and at least one weighting signal, the neuron circuit arranged to output a signal based on at least the at least one data input and the at least one weighting signal; and
at least one weighting refresh circuit arranged to retrieve at least one weighting data value from a memory and to output at least one corresponding weighting signal for the at least one neuron circuit,
wherein the weighting refresh circuit is configured to repeatedly retrieve the at least one weighting data value from the memory at a refresh rate, wherein the refresh rate is dynamic or adjustable.

There is also provided an inference system comprising:
at least one neuron circuit comprising at least one synapse, said synapse comprising a weighting storage element for storing a weighting signal corresponding to a synapse weighting factor and said synapse arranged to receive a data input signal and arranged to output a synapse output signal based on the product of the data input signal and the synapse weighting factor; and
at least one weighting refresh circuit arranged to retrieve a weighting data value from a digital memory and to cause a corresponding weighting signal to be applied to the weighting storage element,
wherein the weighting refresh circuit is configured to repeatedly refresh the weighting storage element at a refresh rate, wherein the refresh rate is dynamic or adjustable in use.

Inference systems where weighting factors are defined by a weighting signal value stored locally to each synapse, for example as a voltage stored on a capacitor, are subject to weighting factor errors due to decay over time of the stored value of the weighting signal, for example due to leakage currents of the capacitor or circuit elements connected to it. To correct such drift in the weighting factors applied the stored weighting signal must be refreshed at a rate fast enough for the required weighting accuracy. If the refresh rate is fixed, this fixed refresh rate must be frequent enough to guarantee that the weighting factors applied will be accurate enough for the inference engine to provide its outputs with less than a specified maximum error rate, allowing for worst-case effects of temperature and any other relevant factors including manufacturing tolerances. In many circumstances this fixed refresh rate will thus be in excess of what is actually necessary for adequate error rate under normal conditions.

Providing an inference system having an adjustable refresh rate for weighting circuits allows the relatively power-hungry operation of refreshing memory weights to be performed only as frequently as actually necessary, thereby providing for reduced overall power consumption of the inference system. It will be understood that the inference system may be provided with an integrated controller to control the adjustment of the refresh rate. Additionally or alternatively, the adjustment of the refresh rate may be controlled using a separate controller device, e.g. a system applications processor (AP) or central processing unit (CPU). Preferably, the inference system is an analog inference system.

Preferably, the refresh rate is adjustable between at least a first frequency and a second frequency higher than the first frequency. Preferably, the first frequency is used to provide a relatively low-accuracy output signal, and wherein the second frequency is used to provide a relatively high-accuracy output signal.

Refreshing the weights at a relatively low frequency rate reduces the power consumption of the system, by reducing the power consumption related to the memory access process and associated switching systems. Such a reduction in refresh rates may however also result in a reduction in the system accuracy, e.g. a relatively high error rate, of the inference system itself.

Preferably, the first frequency is selected such that the reduction in system accuracy is within acceptable parameters, e.g. a reduction from an 8-bit resolution process to a 4-bit resolution process may be acceptable if useful information may still be derived from the 4-bit resolution process. It will be understood that the acceptable accuracy resolution may depend on the operation or function performed by the inference system in question, for example how the system is intended to perform in relatively noisy conditions.

Preferably, the inference system is arranged to switch between at least two operational modes:
a low-refresh-rate mode, wherein the refresh rate is the first frequency; and
a high-refresh-rate mode, wherein the refresh rate is the second frequency.

In some embodiments the first or second frequencies may be pre-defined values and refresh operations may thus occur at regular intervals. In other embodiments a control parameter or threshold may be set according to the mode to generally encourage or discourage refresh operations so that refresh operations occur generally more and less often without defining a particular frequency and the interval between refresh operations may change least slightly from refresh to refresh for example due to temperature fluctuations modulating some control threshold. In the first mode the refresh operation will occur less frequently than in the second mode. In the first mode the intervals between refresh operations may correspond to a first band of refresh frequencies. In the second mode the intervals between refresh operations may correspond to a second band of refresh frequencies. The first band of frequencies may be lower than the second band of frequencies.

Preferably, the inference system is provided as a component of a larger electronic device, e.g. as a battery-powered personal audio device such as a mobile phone, a tablet computer, a personal music player, etc. The system may also be provided as part of a “smart device”, such as a voice assistant device, or an electronic device having embedded voice-processing functionality, e.g. smart televisions, home music players, etc. The controller may be provided as an applications processor (AP) or a central processing unit (CPU) of such a device.

The inference system may be maintained in the first low-refresh-rate mode if the electronic device is in a substantially inactive or relatively low-power mode. For devices having audio-processing capabilities, e.g. systems utilising speaker identification or verification, or speech recognition systems, the inference system may be maintained in the first low-refresh-rate mode for an always-on listening mode, where the device is maintained in a relatively low-power state while processing audio received by the device.

The inference system may be maintained in the high-refresh-rate mode after the electronic device is activated or woken from a low-power state.

The switching between refresh-rate modes of the system or adjustment of the refresh rate may be based on a number of different factors.

In a first aspect, for portable or battery-powered devices, e.g. mobile phones, tablet computers, laptops, personal music players, etc., the switching from the low-refresh-rate mode to the high-refresh-rate mode or the adjustment of the refresh rate may be based on a voltage level of a power supply associated with the inference system; a power supply source of a device incorporating the inference system; or a power mode of a device incorporating the inference system.

For example, the system may switch from the low-refresh-rate mode to the high-refresh-rate mode or the refresh rate may be increased if the electronic device has access to the mains power supply, or if the electronic device is charging its battery, e.g. using a wired or wireless charging station.

Additionally or alternatively, the system may switch from the high-refresh-rate mode to the low-refresh-rate mode or the refresh rate may be decreased if the electronic device is operating on battery power, if the remaining battery capacity of the electronic device is below a threshold level of remaining power, and/or if the electronic device is operating overall in a power conservation mode. Additionally or alternatively, a controller of the device may define a power mode in which the current taken by the inference system must be below a maximum value: the refresh controller may receive an indication of the supply current the inference system or a portion thereof is consuming and adjust the refresh rate accordingly.

Additionally or alternatively, the system may operate in the low-refresh-rate mode or at a low refresh rate until receiving a signal indicative of a user interaction with the electronic device, e.g. a direct user input, such as a mechanical button press or other touch-based interaction with the device, or an indication that a user may interact with the device, e.g. using a proximity sensor to detect the approach of a user.

In a further aspect, the inference system is configured to generate an output based on a received input signal, wherein the refresh rate is adjustable based on characteristics or features of the received input signal.

For example, the refresh rate may be adjustable based on the signal-to-noise ratio of the received input signal, wherein the refresh rate increases as the signal-to-noise ratio (SNR) of the received input signal increases. I.e. when the signal is cleaner, then it is more worthwhile to perform high-accuracy calculations.

In some embodiments, it may be worthwhile to increase the refresh rate when the SNR decreases, in cases where more accurate processing is required to process a relatively noisy input signal.

As signal characteristics of the received input signal may determine the relative ease or difficulty of any subsequent inference operation, accordingly the refresh rate may be adjusted to compensate for variations in received signal quality, and to provide the best balance of relative power consumption with accurate outputs from the inference system. Examples of other signal characteristics may include signal level or amplitude, or any other suitable quality metric.

For devices performing audio processing on received audio, the system may switch from the low-refresh-rate mode to the high-refresh-rate mode or increase the refresh rate based on the output of one or more of the following audio-processing modules:
a voice activity detection module (VAD) arranged to indicate the presence of speech in received audio;
a voice keyword detection module (VKD) arranged to indicate the presence of a keyword or wake-word in received audio;
a speaker identification or verification module arranged to indicate the identity or authorisation of a speaker of the received audio;
a command recognition module arranged to recognise commands present in speech in the received audio; and
an audio quality metrics module arranged to determine at least one indication of the signal quality of the received audio, e.g. signal-to-noise level, signal amplitude, bandwidth metrics, etc.
an acoustic environment determination module arranged to determine at least one indication of the user's environment (for example in an office, on a train, etc.)

It will be understood that outputs for the above described audio-processing modules may be at least partly generated by the inference system when operating in the low-refresh-rate mode or at a relatively low refresh rate. In particular, the inference system may process received audio in a relatively low-power always-on mode to determine if there is information of interest in the received audio, wherein on detecting the presence of such information of interest, the inference system triggers the transition to the relatively high-power, high-refresh-rate mode. In such a system, the inference system may be connected with a data buffer, such that the inference system may process the received audio twice—firstly when in the relatively low-power, low-refresh-rate mode, and secondly when in the relatively high-power, high-refresh-rate mode. The low-power mode of the inference system may be said to power-gate the subsequent relatively high-power, more accurate processing of the received audio.

Alternatively, the inference system may be coupled with an external audio processing module, e.g. as part of a connected digital signal processor or CODEC device, which is configured to implement at least one of the above-described audio-processing modules.

In a further aspect of the present disclosure, the refresh rate may be adjusted based on the operational parameters of the inference system.

In one embodiment, the refresh rate may be adjusted based on the operational temperature of the inference system.

As temperature increases, accordingly circuit leakage current may also increase, which may translate into increased weighting errors and hence an increase in error rate. Accordingly, the inference system may require increased refresh rate for stored weights as the temperature increases. In such a system, the temperature of a circuit die may be measured using an on-chip band gap temperature sensor for example.

In one aspect of the present disclosure, the refresh rate may be adjusted based on the output of a memory reference cell.

Preferably, the inference system comprises at least one memory reference cell, the memory reference cell arranged to receive a weighting signal from a weighting refresh circuit, the weighting signal being stored in the memory reference cell, wherein the memory reference cell is configured to monitor the level of the stored weighting signal, and wherein the memory reference cell is arranged to trigger a refresh of the weighting storage elements for at least a portion of the inference system if the magnitude of the error in the monitored weighting signal exceeds a threshold value.

The memory reference cell may be designed as a replica of the weighting storage element and associated circuitry storing the weight values in the active neurons, and will be subject to the same influences of manufacturing tolerances and temperature and so forth. By monitoring over time an output of a memory reference cell, accordingly the system may monitor for possible leakage or weight decay in the stored weight values of the neuron circuits of the system. Once the monitored output deviates by more than some defined error threshold, this may be indicative of a need to refresh the stored weights in at least a portion of the other neuron circuits, to compensate for any possible leakage or weight decay in those circuits. The permissible error threshold value for the memory reference cell may be selected based on any suitable parameters, for example allowable tolerance values for the inference system. It will be understood that the system may comprise multiple reference cells distributed throughout the inference system, wherein the reference cells may trigger a relatively local memory refresh for adjacent weighting circuits. The deviation of the stored weighting signal, e.g. the voltage on a storage capacitor, may be monitored over time versus an upper or lower threshold directly, or alternatively the deviation over time of the stored weighting signal may be monitored indirectly by monitoring some dependent signal value, e.g. a current derived from a stored voltage, versus appropriate upper or lower thresholds. The dependent signal value may be more directly representative of an applied synapse weighting factor.

In a further aspect, the allowable threshold level of the memory reference cell may be adjusted based on a desired accuracy level of the inference system. The desired accuracy level may be defined in terms of a selected one of a plurality of defined accuracy modes, as selected by software elsewhere in the system or by an accuracy controller as described below.

In another aspect of the present disclosure, a refresh operation may be triggered based on a calculation cycle, or as an on-demand refreshing of system memory.

In some applications, an inference system may be required to provide an output only at an time period longer than the processing time necessary to provide the result. The inference system may this be idle over predictable time intervals. The weighting signal refresh may be thus advantageously be scheduled to occur during these idle time intervals, to avoid interfering with the signal processing.

Some inference systems may comprise successive layers of neural net processing, each passing output signals to the next layer but otherwise operating independently. If the processing delay though a layer is less than the time period at which the inference system output is required, then there will be a predicable time interval during which the layer may not be required to perform processing. The weighting signal refresh may be thus advantageously be scheduled to occur during these idle time intervals of individual layers, to avoid interfering with the signal processing. The idle time intervals of successive layers may appear successively as the signal processing ripples through the layers.

If the idle time interval of the inference system or of a layer thereof is long compared to the time required to refresh all the relevant synapses, the refresh operation may advantageously be delayed until near the end of the idle time interval, to reduce the time available for the weighting signal to decay before being used.

Accordingly, in such systems, the inference system may be configured to determine or predict when an inference operation is required, on a system-level-basis, layer-by-layer basis, or on a neuron circuit-level basis, and may be configured to perform either a memory refresh operation, or a memory check operation which may trigger a memory refresh operation in advance of the determined or predicted inference operation.

In another aspect, the inference system is operable to perform a calibration operation (for instance during factory calibration of an integrated circuit or end-user electronic device comprising the inference system, or on power-up of such a device) wherein the data inputs for the at least one neuron circuit are set to known input values and the output of the at least one neuron circuit is compared to an expected output value, and wherein if the output is different to the expected output value the respective weighting storage element is refreshed with a modified weighting signal value. This modified weighting signal value may be derived from a modified weighting data value, which may be retained in memory, for example over-writing a previous value, for use in future refresh operations. Preferably, the refresh with a modified value is performed if the output is different by a threshold value from the expected output value. The threshold may be set by an accuracy requirement for the system, e.g. 5%, 10%, 12.5%, 20%, 25% difference threshold.

In another aspect of the present disclosure, the inference system comprises a plurality of weighting storage elements, wherein the different weighting storage elements are refreshed at different refresh rates.

The inference system may have different refresh rates for different weighting storage elements based on how important the respectively associated neuron circuits are. As an example, for a multiple-layer machine learning or neural net system, those neuron circuits located in the initial layers may have a higher refresh rate than those neuron circuits located in later layers of the system, due to the need for increased accuracy in the initial layers of the system.

In an aspect of the present disclosure, the refresh rate may be adjustable based on the magnitude of the weighting factor value associated with the weighting storage element to be refreshed.

For example, the system may determine relative magnitudes of the weighting factor values corresponding to weighting data values stored in memory, and to adjust the refresh rates of the weighting circuits associated with such weighting factor values based on the relative magnitudes.

As an example, if it is determined that the magnitude of the weighting factor value is relatively small, the corresponding weighting storage element may be refreshed at a relatively low refresh rate, as the importance of the weighting factor value itself is relatively low when compared to other weighting factor values. Similarly, if it is determined that the magnitude of the weighting factor value is relatively large, the corresponding weighting storage element may be refreshed at a relatively high refresh rate, as the importance of the weighting factor value itself is relatively high when compared to other weighting factor values.

Accordingly some individual synapses or layers or other subsets of the synapses in the system may be identified or labelled as exhibiting less sensitivity to weighting factor error and thus be refreshed less often.

It will be understood that the inference system may be provided as part of a circuit element or integrated circuit device for use in a larger circuit.

Preferably, the inference system comprises digital memory storage to store the weighting data values that may be used by the weighting refresh circuit to refresh the respective locally stored weighting signal for each synapse. Providing a dynamic or adjustable refresh rate helps reduce the power consumed in reading the values from the digital memory. However, many forms of digital memory exhibit relatively high leakage currents even when not being read or written to which might be significant in the overall power consumption budget of a low power inference system.

Thus preferably the digital memory storage is of a form which exhibits relatively low leakage, for instance low leakage varieties of SRAM (Static Random Access Memory) whose design is optimised for low leakage rather than speed. Various forms of non-volatile digital memory also tend to exhibit low leakage, for instance suitable NVRAM (Non-Volatile Random-Access Memory), flash memory, Resistive RAM or Memristors.

The memory may be provided as on-chip memory, i.e. co-integrated as part of an integrated device or I.C with some or all of the inference engine. In particular an integrated circuit implementation may comprise multiple weighting refresh circuits. Each weighting refresh circuit may be close to the neurons with which it communicates. Memory cells may be distributed so that each is close to the weighting refresh circuit with which it communicates. Thus memory cells may be distributed across the surface of the integrated circuit.

Additionally or alternatively, the memory may be provided as a discrete element separate from the inference system itself, e.g. as a separate memory storage element to an integrated circuit comprising the inference system.

In one aspect, the inference system comprises an array of neuron circuits having at least one associated weighting storage element.

In one embodiment, each synapse of each neuron circuit of the array of neuron circuits is provided with a separate weighting storage element. In this case, the weights of each synapse in the neuron circuits of the array may be individually refreshed.

In an alternative embodiment, applicable for example where a plurality of synapses in a neuron array have equal weights, a common weighting storage element may be provided for a subset of synapses, with the shared stored weighting signal distributed across the relevant synapses. Thus only one storage element needs to be refreshed, thereby reducing the memory access operations required for a memory refresh of the whole array of neurons. Integer multiple weights may be obtained by operating a number of these equal-weighted synapses in parallel.

In one aspect, each synapse of the array of neuron circuits comprises a weighting storage element provided with the synapse circuit, possibly physically close.

In an alternative aspect, a weighting storage element may be provided for a subset of neuron circuits of the array, for example a weighting storage element may be provided for each row or column of a two-dimensional array of neuron circuits.

The weighting storage elements and the array of neuron circuits may be provided as part of an integrated device or I.C. comprising the inference system, e.g. to provide on-chip weighting storage.

In a further aspect of the present disclosure, the inference system is configurable to switch between two modes of operation:
a fixed-refresh-rate mode wherein the refresh rate of the inference system is at a fixed rate; and
a variable-refresh-rate mode wherein the refresh rate of the inference system is adjusted in use.

A fixed refresh rate for memory refresh of the inference system provides a system having a guaranteed or predefined power consumption, but this power consumption may be excessive for the desired performance level or may be set too low to obtain desired performance under some conditions. By contrast, by providing a second operational mode wherein the refresh rate is allowed to vary, accordingly the system may adjust the refresh rate as required by the system to guarantee performance. However, such a mode may result in variations in system power consumption, based on the magnitude of the variations in refresh rate required to guarantee performance.

It will be understood that the system may be configured to switch between the modes of operation based on system requirements, e.g. based on a control signal provided from a central controller such as an AP or CPU.

The inference system preferably comprises neurons comprising a rectifier unit or nonlinearity block, which is arranged to provide a rectified output signal based on the product of the at least one data input and the at least one weighting signal.

The rectifier unit or nonlinearity block provides an activation function between the product of the weights and the data inputs and the output of each of these neurons of the inference system.

The weighting refresh circuit may comprise a digital-to-analog converter (DAC) which is configured to receive a digital weighting data value from a digital memory storage, and to convert the digital weighting data value to an analog output signal for refreshing the stored weighting signal stored on the synapse weighting storage element. In some embodiments the analog output signal may be a direct representation of an analog signal to be stored on the weighting storage element, for instance a voltage to be stored on a capacitor. In other embodiments, the analog signal may be an indirect representation of the weighting signal to be stored: for instance the analog output signal may be a current which is then applied across some impedance, for instance a gate-drain-connected MOS transistor which then develops a voltage to be stored as a weighting signal on a storage capacitor.

It will be understood that the DAC may be provided as part of the inference system itself, or may be provided as a separate element to the inference system.

In a preferred embodiment, a DAC may be selectively coupled with a plurality of weighting storage elements, wherein the DAC is configured to output respective analog weighting currents which may be used to provide respective weighting signals to refresh each of the plurality of weighting storage elements

In a preferred aspect, the refresh of the respective weighting storage elements of the plurality by respective weighting signals may be performed at different times by the same DAC.

Such a configuration allows for a reduction in the number of DACs required to provide for memory refresh of the inference system. The refresh times of the individual weighting circuits may be appropriately staggered to allow for the same DACs to be used for multiple different refresh operations.

In some implementations the at least one neuron circuit may comprise compensation circuitry for compensating for any variation in the at least one weighting signal between refresh operations

There is provided an electronic device comprising at least one inference system as described above, and a processor to control the refresh rate of the at least one inference system. The processor may be provided as an applications processor (AP) or a central processing unit (CPU) of such a device. The processor may be arranged to receive the output of the inference system, or the processor may be configured to control the routing of the output of the inference system to additional processing modules of the device.

The device may be provided as a battery-powered personal audio device such as a mobile phone, a tablet computer, a personal music player, etc. The device may also be provided as a “smart device”, such as a voice assistant device, or an electronic device having embedded voice-processing functionality, e.g. smart televisions, home music players, etc. the device may also be provided as a server or other computing device arranged to perform inference. The device may also be provided as an accessory device, for example a digital wired or wireless headset, to co-operate with such devices

It will be understood that the inference system or an associated processor may be provided with an appropriate sequencing or routing module, to control which weighting circuits are to be refreshed.

In a further aspect of the present disclosure a neuron circuit for inference may comprise:
an input to receive a data signal representative of a data input for the neuron circuit;
a controlled current source arranged to output onto an accumulation node a weighting current dependent on the voltage on a control node, via a first switch controlled by the data signal
a weighting storage element connected to the control node
a second switch periodically closed to connect the weighting storage element to a weighting signal source and opened to isolate the weighting storage element.

The data signal may be a PWM signal, or may be some other suitable signal format, for instance a suitable delta-sigma-encoded format.

In some embodiments of the neuron circuit, the controlled source may comprise a first MOSFET; the control node may comprise a gate of the first MOSFET; the weighting signal source may comprise a second MOSFET; the second MOSFET may be arranged to carry a weighting control current and when the second switch is closed the gates of the first and second MOSFETS are connected together and the current through the first MOSFET is proportional to the current through the second MOSFET. In some embodiments the second MOSFET may be gate-drain-connected and the weighting current applied to the drain-gate node.

In some embodiments of the neuron circuit, the controlled source may comprise a first MOSFET; the control node may comprise a gate of the first MOSFET; the weighting signal source may comprise an amplifier; and the neuron circuit may comprise a third switch for connecting the MOSFET to a first node, wherein the first node is connected to a weighting current source and to an input amplifier, wherein the amplifier is configured to output a weighting signal to the control node, when said second and third switches are closed, to regulate a voltage at the first node to be equal to a reference voltage.

The weighting control current may generated by a DAC and may be dependent on a value retrieved from a digital memory storage.

The neuron circuit may further comprise compensation circuitry for compensating for any change in the value of the weighting current. The compensation circuitry may be configured to receive a reference current and, based on the reference current, to control at least one of:
a conversion gain of a controller for controlling the first switch based on the data signal;
a value of capacitance coupled to the accumulation node;
a conversion gain of a converter for generating an output signal based on current supplied to the accumulation node; and
a digital gain applied to a digital output signal from a converter for generating an output signal based on current supplied to the accumulation node.

In some examples the reference current may be received from a matched reference cell comprising a reference controlled current source a weighting storage element. In some examples, where the neuron circuit includes a plurality of controlled current sources and respective weighting storage elements, each controlled current source for outputting a respective weighting current onto the accumulation node, via respective first switches controlled by respective data signal, the reference current may formed from a combination of said weighting currents.

In some embodiments the neuron circuit may comprise an output capacitor connected to the accumulation node. The neuron circuit may be configured to operate in at least two phases, a computation phase in which the first switch is controlled by the data signal to output the weighting current to the accumulation node to charge the output capacitor, and a read-out phase in which the charge accumulated on the output capacitor is determined. Read-out circuitry may comprise a discharge current circuit configured to generate a defined discharge current for discharging the output capacitor and a comparator for comparing a voltage of the output capacitor to a threshold. The read-out circuit may be configured such that the defined discharge current varies to compensate any variation in the weighting current.

There is further provided an inference system comprising at least one neuron circuit comprising at least one synapse, said synapse arranged to:
receive a weighting signal corresponding to a synapse weighting factor;
receive a data input signal; and
output a synapse output signal based on the product of the data input signal and the synapse weighting factor;
   and wherein the inference system further comprises:
at least one accuracy control input, to adjust an accuracy level of the synapse weighted output.

Providing an adjustable accuracy level of the inference system allows for the processing level and associated power consumption of the inference system to be increased or reduced as required. The accuracy level may be adjustable by adjusting the resolution of the data processed by the inference system, and/or by adjusting the performance to control the error rate of the inference system. It will be understood that the inference system may be provided with an integrated controller to control the adjustment of the accuracy level of the inference system. Additionally or alternatively, the adjustment of the accuracy level of the inference system may be controlled using a separate controller device, e.g. a system applications processor (AP) or central processing unit (CPU).

Preferably, the inference system is configurable to switch between:
a low-accuracy mode of operation, having a first accuracy level; and
a high-accuracy mode of operation, having a second accuracy level, the first accuracy level lower than the second accuracy level.

It will be understood that the low-accuracy mode is configured for relatively low-power, low-accuracy inference operations, while the high-accuracy mode is configured for relatively high-power, high-accuracy inference operations.

Preferably, the inference system is provided as a component of a larger electronic device, e.g. as a battery-powered personal audio device such as a mobile phone, a tablet computer, a personal music player, etc. The system may also be provided as part of a “smart device”, such as a voice assistant device, or an electronic device having embedded voice-processing functionality, e.g. smart televisions, home music players, etc. The controller may be provided as an applications processor (AP) or a central processing unit (CPU) of such a device.

The inference system may be maintained in the low-accuracy mode if the electronic device is in a substantially inactive or relatively low-power mode. For devices having audio-processing capabilities, e.g. systems utilising speaker identification or verification, or speech recognition systems, the inference system may be maintained in the low-accuracy mode for an always-on listening mode, where the device is maintained in a relatively low-power state while processing audio received by the device.

The inference system may be maintained in the high-accuracy mode after the electronic device is activated or woken from a low-power state.

The inference system may comprise a plurality of subsets of neurons and the accuracy level of one subset may be adjusted to be different to another subset in at least one of the low-accuracy mode or the high-accuracy mode.

This may allow the power versus performance trade-off of each layer to be adjusted optimally.

The switching between accuracy modes of the system may be based on a number of different factors.

In a first aspect, for portable or battery-powered devices, e.g. mobile phones, tablet computers, laptops, personal music players, etc., the switching from the first low-accuracy mode to the second high-accuracy mode may be based on the power supply for the device.

For example, the system may switch from the first low-accuracy mode to the second high-accuracy mode if the electronic device has access to the mains power supply, or if the electronic device is charging a battery, e.g. using a wired or wireless charging station.

Additionally or alternatively, the system may switch from the second high-accuracy mode to the first low-accuracy mode if the electronic device is operating on battery power, if the remaining battery capacity of the electronic device is below a threshold level of remaining power, and/or if the electronic device is operating in a power conservation mode.

Additionally or alternatively, the system may operate in the first low-accuracy mode until receiving a signal indicative of a user interaction with the electronic device, e.g. a direct user input, such as a mechanical button press or other touch-based interaction with the device, or an indication that a user may interact with the device, e.g. using a proximity sensor to detect the approach of a user.

For devices performing audio processing on received audio, the system may switch from the first low-accuracy mode to the second high-accuracy mode based on one or more of the following:
a voice activity detection module (VAD) indicating the presence of speech in received audio;
a voice keyword detection module (VKD) indicating the presence of a keyword or wake-word in received audio;
a speaker identification or verification module indicating the identity or authorisation of a speaker of the received audio;
a command recognition module arranged to recognise commands present in speech in the received audio; and
an audio quality metrics module arranged to determine at least one indication of the signal quality of the received audio, e.g. signal-to-noise level, signal amplitude, bandwidth metrics, etc.
an acoustic environment determination module arranged to determine at least one indication of the user's environment, e.g. in an office, on a train, etc.

It will be understood that outputs for the above described audio-processing modules may be at least partly generated by the inference system when operating in the first low-accuracy mode. In particular, the inference system may process received audio in a relatively low-power always-on mode to determine if there is information of interest in the received audio, wherein on detecting the presence of such information of interest, the inference system triggers the transition to the relatively high-power, high-accuracy mode. In such a system, the inference system may be connected with a data buffer, such that the inference system may process the received audio twice—firstly when in the relatively low-power, low-accuracy mode, and secondly when in the relatively high-power, high-accuracy mode.

Alternatively, the inference system may be coupled with an external audio processing module, e.g. as part of a connected digital signal processor or CODEC device, which is configured to perform at least one of the above-described audio-processing modules.

Preferably, the accuracy level is adjusted based on adjustment of the refresh rate of the weighting storage elements for an inference system as described above.

Alternatively or additionally, the accuracy level is adjusted by adjustment of the resolution of the data processed by the inference system, for example adjustment of the resolution of operations of data conversion to provide a PWM input or output signal for neurons of the inference system, or the resolution or coarseness of a non-linear activation function block.

By providing for different quantisation of the input or output signals of the neurons of the inference system, accordingly the power consumption related to maintaining a relatively high resolution of data may be reduced with a corresponding reduction in accuracy. Providing for reduced quantisation of processed data may result in signification reductions in power consumption for inference systems which are relatively “data-heavy”, e.g. convolutional neural networks.

There is provided an electronic device comprising at least one an inference system as described above, and a processor device to control the refresh rate of the at least one inference system.

The device may be provided as a battery-powered personal audio device such as a mobile phone, a tablet computer, a personal music player, etc. The device may also be provided as a “smart device”, such as a voice assistant device, or an electronic device having embedded voice-processing functionality, e.g. smart televisions, home music players, etc. The electronic device 100 may also be provided as an accessory device, for example a digital wired or wireless headset, to co-operate with such devices. The device may also be provided as a server or other computing device arranged to perform inference. The processor may be provided as an applications processor (AP) or a central processing unit (CPU) of such a device. The processor may be arranged to receive the output of the inference system, or the processor may be configured to control the routing of the output of the inference system to additional processing modules of the device.

### DETAILED DESCRIPTION

Embodiments will now be described, by way of example only, with reference to the accompanying drawings, in which:

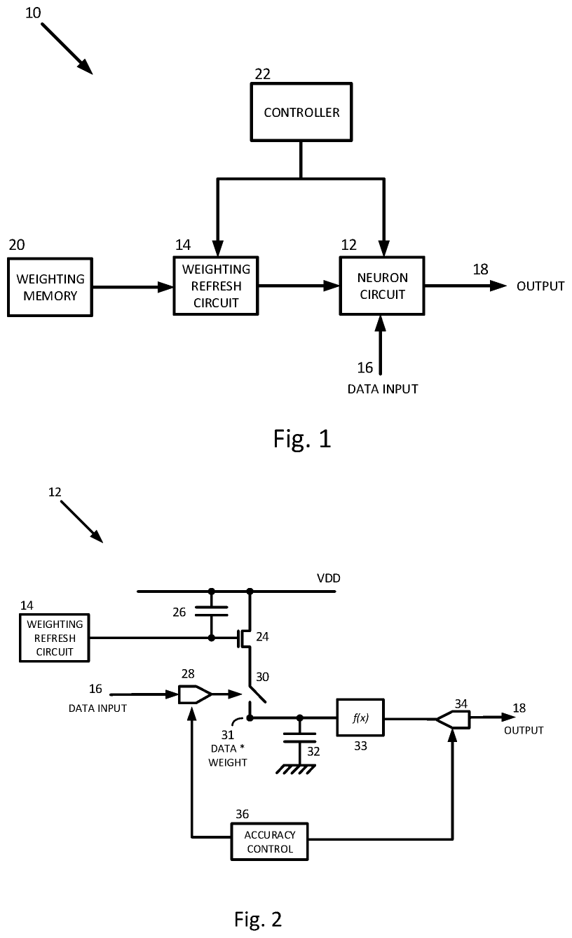

FIG. 1 is an illustration of an inference system according to the present disclosure;

FIG. 2 is an illustration of a neuron circuit comprising a synapse of the inference system of FIG. 1;

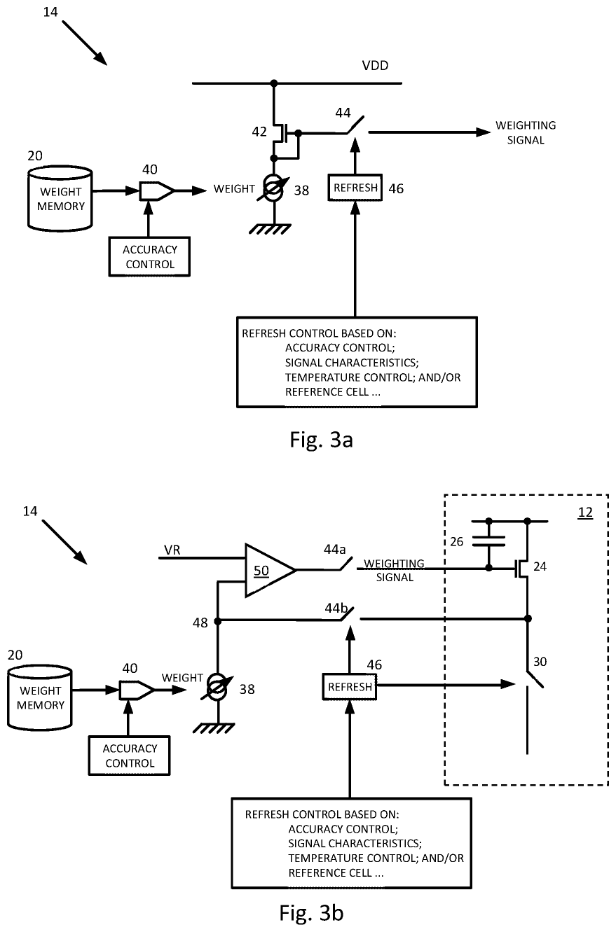

FIGS. 3a and 3b illustrate two examples of weighting circuits of the inference system of FIG. 1;

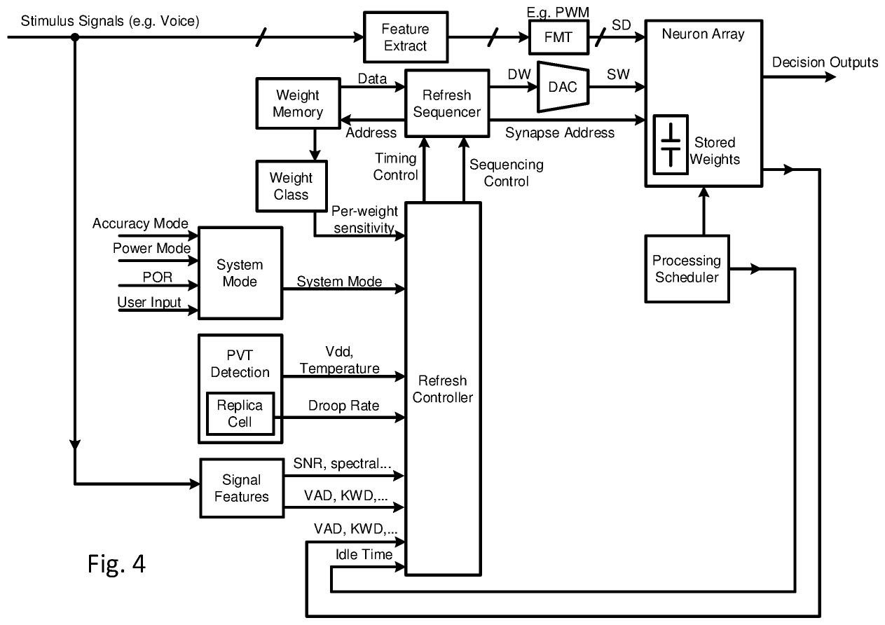

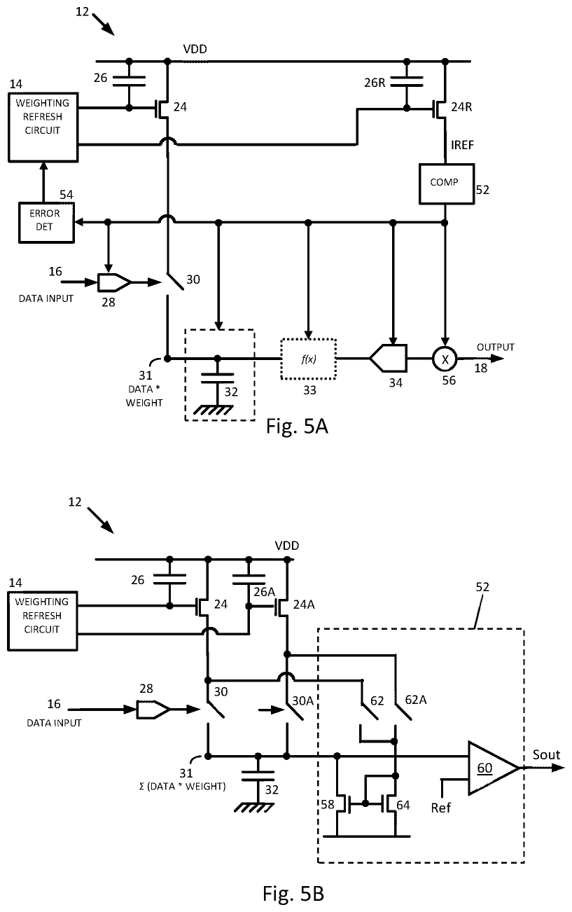

FIG. 4 is an illustration of a first control scheme for the inference system of FIG. 1;

FIGS. 5A and 5B illustrate two examples of neuron circuits including droop compensation;

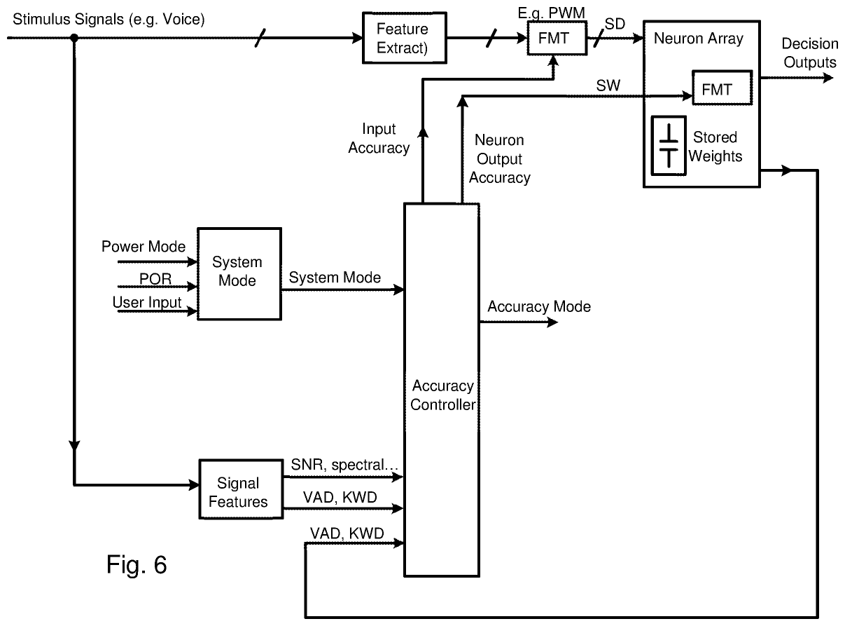

FIG. 6 is an illustration of a second control scheme for the inference system of FIG. 1;

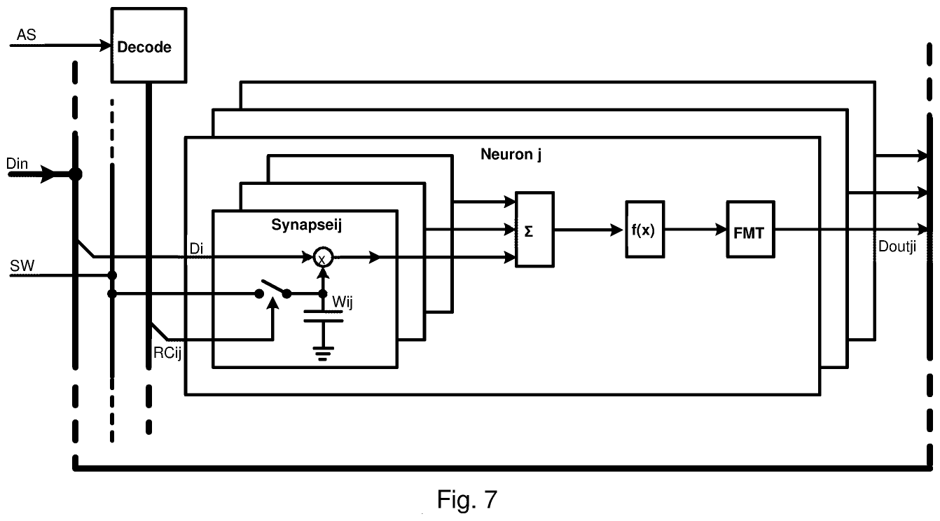

FIG. 7 is a second illustration of an inference system according to the present disclosure; and

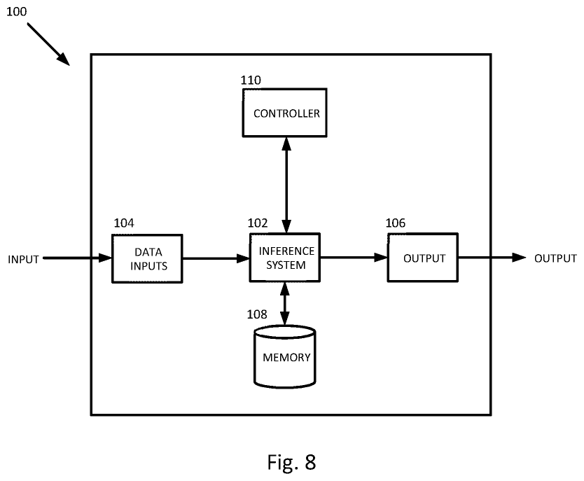

FIG. 8 is an illustration of an electronic device comprising an inference system according to the present disclosure.

With reference to FIG. 1, an inference system according to an aspect of the present disclosure is illustrated at 10. The inference system 10 comprises a processing circuit 12, which will be referred to herein as a neuron circuit or simply a neuron, and a weighting refresh circuit 14. The neuron circuit is configured to receive a data input 16 and to receive a weighting signal from the weighting refresh circuit 14, and to output a signal 18 based on the product of the data input and a weighting factor based on the weighting signal.

The neuron circuit 12 may be implemented to perform at least some computing in the analog domain, as will be described below. Data processing in the digital domain, for instance based on the Von Neumann architecture, may generally involve sequential processing operations in a processor core, each involving associated memory reads and writes. Conventional digital processing based on the Von Neumann architecture may thus have disadvantages in terms of processing throughput and/or power consumption in applications such an inference using a neural net, whereas analog computing can be arranged for large scale parallel operations and can be implemented to be relatively low power. Some embodiments of the disclosure thus relate to neuromorphic computing and may use at least some analog or mixed-signal circuitry to implement a model of a neural system.

It will be understood that the neuron circuit 12 may be configured to receive multiple data inputs and/or multiple respective weighting signals. The output signal 18 may then be based on the products of multiple data inputs and respective weighting factors based on the respective weighting signals. Each product may be regarded as the output of a synapse of the neuron circuit. The output signal 18 may be derived by applying a non-linear function to the sum of the products. In other words the neuron circuit 12 may be configured to generate a dot product of a vector of multiple data inputs with a respective vector of respective weight values and apply a non-linear function, e.g. an activation function, to the dot product.

In addition, it will be understood that the inference system 10 may comprise multiple neuron circuits and/or weighting circuits. Similarly, multiple inference systems may be provided as part of a larger inference array in a learning system or neural network system for the processing of received data.

The weighting refresh circuit 14 is arranged to retrieve at least one weighting data value from a weighting memory 20, and to output at least one weighting signal to the neuron circuit 12. The weighting memory 20 may be loaded with weighting data values that correspond to appropriate data weighting factors previously derived from a machine learning or training process. The operation of the inference system 10, and in particular the operation of the neuron circuit 12 and/or the weighting refresh circuit 14 may be controlled in use to provide for reduced power consumption of the inference system 10.

In one embodiment, the inference system 10 comprises a controller 22, which is arranged to control the operation of the neuron circuit 12 and/or the weighting refresh circuit 14. The controller 22 may be provided as an integrated controller which is part of the inference system 10. Additionally or alternatively, the controller 22 may be provided as a separate controller device, e.g. a system applications processor (AP) or central processing unit (CPU).

To avoid having to continuously drive and supply a weighting signal to a neuron, the neuron may be arranged to comprise a weighting storage element which only requires refreshing from time to time. It has been found that by dynamically adjusting the rate at which a weighting storage element is refreshed by the inference system, a reduction in the overall power consumption of the inference system 10 may be obtained. Additionally or alternatively, a reduction in the overall power consumption of the inference system 10 may be obtained by dynamically adjusting the accuracy level of the inference system 10.

FIG. 2 illustrates a single-synapse embodiment of the neuron circuit 12 of FIG. 1, when implemented as an analog computing system. An analog weighting signal output of the weighting refresh circuit 14 from FIG. 1 is provided to the gate of a first MOSFET 24 of neuron circuit 12. A storage capacitor 26 may be connected to the gate of MOSFET 24 and also charged by the weighting signal output of the weighting refresh circuit 14. The value of the weighting signal is configured such that the gate-source voltage of transistor 24 causes it to pass a current proportional to a desired weighting factor, for example a low current for a small weighting factor or a proportionally high current for a large weighting factor.

The neuron 12 also receives a data input 16 which may be provided as an analog signal, or may be provided as a digital signal, possibly multi-bit. The data input is converted to a two-level signal format using converter 28. The data input is converted into a format in which the value of the signal is represented as a pulse duration or a duty-cycle over a given sample period of the converted signal, for instance one of the many known forms of PWM (Pulse-Width Modulation) signal. It will be understood that converter 28 may be provided as a separate element to the inference system 10.

The output of the converter 28 is used to control the operation of a switch 30, which is provided in series with the drain of the MOSFET 24, and which may also be a MOSFET. As the pulse width or duty cycle of the output of the converter 28 represents the data input 16, and switch 30 regulates the flow of current through the MOSFET 24 with this duty cycle or pulse width, and as the current through MOSFET 24 is based on the value of the weighting current defined proportional to a desired weighting factor by the weighting refresh circuit 14, accordingly the output from the switch 30 is a modulated current signal representative of the product of the data input and the desired weighting factor. This current is accumulated over a given period of time as charge on accumulation node 31 to which output capacitor 32 is connected so that by the end of the sample period the voltage developed on the accumulation node represents the product of the data input and the desired weighting factor.

The value of the signal stored on the output capacitor 32 may then be subjected to a non-linear transfer function f(x) 33 representing an activation function for the neuron. For example, f(x) may rectify the signal relative to a defined threshold level or may provide a sigmoid non-linearity as is known in the art.

The output of non-linear transfer function 33 may be output as an analog output signal, for example for processing by a subsequent layer of an analog inference system or by processing by any other suitable analog computing module. Alternatively, the output of non-linear transfer function 33 may be converted by a converter 34. Converter 34 may be a multi-bit analog-to-digital converter to provide a digital output. Converter 34 may be a PWM converter to provide a pulse-width or duty-cycle modulated signal representation of the output signal which may serve directly as an input for other synapses or neurons. In any case, the output signal of the neuron circuit 12, whether analog or digital or PWM, may be provided as an output 18 of the inference circuit 10.

To reduce the power consumption of the inference system 10, it is possible to adjust the accuracy level of the input converter 28 and/or the output converter 34 or other components of the neuron. This may be done by adjusting the resolution or quantisation or coarseness of the signals output by the converter 28 or converter 34, or non-linearity function block 33, to provide signals having reduced accuracy. The adjusting may be controlled using accuracy control module 36, and is described in more detail below.

FIG. 3a illustrates one embodiment of the weighting refresh circuit 14 of FIG. 1, when implemented as an analog computing system. The weighting refresh circuit 14 comprises a current source 38 which is controlled by a weighting data value retrieved from the weight memory 20. The weight memory 20 is accessed to provide a digital weighting data value which is converted into an analog weight value by a digital-to-analog converter 40. The analog weight value controls the output of the controlled current source 38. In some embodiments converter 40 and current source 38 may be replaced by an equivalent current-output DAC (IDAC). In either case the output current is passed to a node that is connected to the gate and drain of a MOSFET 42. The gate of the MOSFET 42 is further connected via a switching mechanism 44 to the output of the weighting refresh circuit 14, which is used as an input to the neuron circuit 12 of FIG. 2 for charging of the storage capacitor 26 and defining the gate voltage and drain current of MOSFET 24. In some embodiments MOSFET 42 may be designed identical to MOSFET 24 and so the current though MOSFET 24 will mirror the current through MOSFET 42. Accordingly, the current though MOSFET 24 is defined to be equal to the current though MOSFET 24 which is in turn defined by the digital weighting data value retrieved from weight memory 20. In other similar embodiments the geometries of transistors 24 and 42 may be scaled to provide a fixed scaling factor for the currents.

In some embodiments, the MOSFET 42 and switch 44 may be located in the neuron 12. This requires a MOSFET 42 for each neuron but has the advantage of better matching with MOSFET 24 in terms of process parameters, supply voltage and temperature. In the case of multiple neurons or weighting storage elements a suitable switching matrix would be interposed between current source 38 and the transistor 42 connection of each of the neurons. The weighting refresh circuit output could thus be regarded as a current, but would still generate a similar weighting signal voltage on the weighting refresh circuit output node.

FIG. 3b illustrates a further example of a weighting refresh circuit 14 according to an embodiment, when implemented as an analogue computing system. The weighting refresh circuit 14 comprises a current source 38 which may be controlled by a weighting data value retrieved from the weight memory 20 and converted by DAC 40 as discussed above in relation to FIG. 3a. Again in some embodiments converter 40 and current source 38 may be replaced by an equivalent current-output DAC (IDAC).

In the example of FIG. 3b, the current from current source 38 is supplied to a node 48, which is also coupled to an input of amplifier 50, which also receives a reference voltage VR. During weight refresh (and during an initial weight setting), switch 44a is closed to connect the output of the amplifier 50 to the gate of MOSFET 24 and to the storage capacitor 26, i.e. to provide the weighting signal, and switch 44b is closed to connect the drain of MOSFET 24 of the neuron circuit to node 48. The switch 30 of the neuron circuit is also be opened. The amplifier 50 controls the gate voltage of MOSFET 24, and the charge of storage capacitor 26, so that the voltage at node 48 becomes equal to the reference voltage, and the current passing through MOSFET 24 is equal to the weight current generated by the current source 38. At the end of the refresh period switches 44a and 44b may be opened. In some embodiments the switches 44a and/or 44b may be located in the neuron 12. The arrangement of FIG. 3b does not rely on any transistor matching within a neuron circuit.

In the examples of FIG. 3a and FIG. 3b a voltage corresponding to a desired weighting factor may thus be initially stored on the storage element 26. However a practical capacitor and switch (for instance a MOS transistor switch) will suffer from leakage currents, for instance sub-threshold drain-source current or junction leakage form source or drain for a MOS transistor switch. Thus the synapse will require to be re-selected to refresh periodically in order to ensure that the stored memory value remains accurate.

In the examples of FIG. 3a or FIG. 3b it is possible to control the switching frequency of the switching mechanism 44 or 44a/44b, using a refresh controller 46, in order to control in use the rate at which the storage capacitor 26 of the neuron circuit 12 is refreshed. As a significant portion of the power consumption of the inference system 10 is attributable to the refresh operation for refresh of the weighting storage elements of the inference system, involving retrieval of the weighing value data from the digital memory, possibly off-chip, and activating the current source 38 and associated control, accordingly by providing a dynamic adjustment of the memory refresh rate the overall power consumption of the system may be reduced.

The refresh control may be controlled based on a number of different factors, for example a received accuracy control parameter; signal characteristics of the input signal or data signal to be processed by the inference system; a signal representing die temperature; and/or weight error monitored on a reference memory (i.e. weight storage) cell.

With reference to FIG. 4, an example of an inference system comprising a weight refresh controller is illustrated, which operates to reduce the power consumption of the inference system by having an adjustable or dynamic memory refresh rate.

The inference system comprises a neuron array of neuron circuits interlinked to provide a neural network. The neurons are arranged to store weighting signal values using storage capacitors as weighting storage elements, as described above for example. The neuron array provides an array of decision outputs based on the product of weighting factors corresponding to the stored weighting signals and a plurality of stimulus signals or data inputs received by the inference system, e.g. audio signals, voice signals, optical signals, etc.

In a preferred aspect, a feature extraction operation is performed on the stimulus signals, with a format conversion FMT (e.g. PWM modulation) performed on the feature extracted version of the data to provide the data inputs SD to the neuron array.

The neuron array is configured so that the weighting signals stored on the weighting storage elements may be refreshed, using appropriate weighting refresh circuits as described above. Such a refresh may be coordinated using a refresh sequencer which is configured to instruct which particular weighting storage elements of the array are to be refreshed (using the synapse address channel), and with what values (using the digital weight value DW which may be converted to an analog current SW using a DAC).

The refresh sequencer is further configured to perform the retrieval of the appropriate weight values from the weight memory using data and address lines.

Timing control and/or sequencing control of the refresh sequencer may be provided from a refresh controller, which is configured to adjust the refresh rate of the weighting storage elements.

The refresh controller may control the variation of the refresh rate based on one or more of the following factors.

In one aspect, the refresh controller may adjust the refresh rate of the neuron array based on a per-weight sensitivity. For example, based on the class of weight identified, whether a weight is a significant value or not, then the refresh rate for that particular weight class may be adjusted accordingly. For example, the system may determine relative magnitudes of the weighting factor values corresponding to the weighting data values stored in memory, and adjust the refresh rates of the weighting circuits associated with such values based on the relative weighting factor magnitudes.

As an example, if it is determined that the magnitude of the weight factor value is relatively small, the corresponding weighting storage element may be refreshed at a relatively low refresh rate, as the importance of the weighting factor value itself is relatively low when compared to other weighting factors. Similarly, if it is determined that the magnitude of the weighting factor value is relatively large, this may be refreshed at a relatively high refresh rate, as the importance of the weighting factor value itself is relatively high when compared to other weights.

As another example, for a multiple-layer machine learning or neural net system, those neuron circuits located in the initial layers may have a higher refresh rate than those neuron circuits located in later layers of the system, due to the need for increased accuracy in the initial layers of the system. The refresh controller may store a list of neuron circuits or synapses requiring higher or lower accuracy or may store a table of weight sensitivity values versus synapse weighting storage addresses.

In another aspect, the refresh rate may be controlled based on a system mode setting, which may include one or more of the following:
An accuracy mode;
A power mode;
A POR mode; or
A user input/detection.

As a first example, if the system is configured for a low-accuracy mode, then the refresh rate may be set relatively low, in order to conserve power. Alternatively, if the system is configured for a high-accuracy mode, then the refresh rate may be set relatively high, to ensure accurate performance. The system accuracy mode may be set by a system controller and/or may be set by an output of an accuracy controller for example as described below with respect to FIG. 6.

As a second example, if the system is used in a portable device, and it is detected that the device is currently operating in a power mode using a mains power supply or while in the process of recharging a battery from an external power supply, then the refresh rate may be set relatively high due to the reduced emphasis on device power consumption. Conversely, if the system is used in a device which is in a power mode operating on battery power, and/or if the device is set in an overall power conservation or idle mode, then the refresh rate may be set relatively low to provide reduced power consumption. A controller of the device may define a power mode in which the current taken by the inference system must be below a maximum value: the refresh controller may receive an indication of the supply current it is consuming and adjust the refresh rate accordingly.

As a third example, when the device is first turned on a power-on-reset (POR) function may directly (or indirectly via another system control or applications processor) indicate this to the Refresh Controller, prompting it to cycle though all the weighting storage elements to set each of them to the respective desired value before the inference engine is activated.

As a further example, if the device is in an idle mode not receiving user input, the refresh rate may be relatively low. Conversely, if a user input is received, e.g. via mechanical input or any other detected user interaction such as a voice command or similar, or if the device determines that a user might be about to interact with the device, e.g. using a proximity detect or image analysis of an approaching user, then the refresh rate may be increased. It will be understood that the processing required to provide some of the above-described user approach or proximity analysis may be performed by the neuron array itself.

In another aspect, the refresh rate may be controlled based on a PVT (Process Voltage Temperature) detection module. Such a module may monitor one or more power supply voltages Vdd or the temperature of the system and adjust the refresh rate to compensate for anticipated variations in the device performance. For example, as temperature increases, accordingly circuit leakage current may also increase, which may translate into an increase in error rate. Accordingly, the inference system may require increased refresh rate for weighting storage elements as the temperature increases. In such a system, the temperature of a circuit die may be measured using a band gap temperature sensor for example.

The PVT detection module may also use a memory reference cell or replica cell to trigger refreshing of the weighting storage elements. Such a memory reference cell may be designed to comprise a similar weighting storage element and associated circuitry as other synapses or neurons and thus will be subject to the same influences of manufacturing tolerances and temperature and so forth and thus exhibit similar weighting storage decay characteristics, but is not used for actual computation. The memory reference cell or replica cell can be seen as a matched reference. By monitoring over time an output of a memory reference cell, accordingly the system may monitor for possible leakage or weight decay in the stored weight values of the neuron circuits of the system. Once the monitored output deviates by more than some defined error threshold, this may be indicative of a need to refresh the stored weights in at least a portion of the other neuron circuits, to compensate for any possible leakage or weight decay in those circuits. The permissible error threshold value for the memory reference cell may be selected based on any suitable parameters, for example allowable tolerance values for the inference system. In some examples the output of a memory reference cell or replica cell may additionally be used to compensate for any variation in the weight currents between refresh operation as will be discussed in more detail with reference to FIG. 5A.

It will be understood that the system may comprise multiple reference cells distributed throughout the inference system, wherein the reference cells may trigger a relatively local memory refresh for adjacent weighting circuits.

The deviation over time of the stored weighting signal, e.g. the voltage on a storage capacitor, may be monitored versus an upper or lower threshold directly, or alternatively the deviation over time of the stored weighting signal may be monitored indirectly by monitoring some dependent signal value, e.g. a current derived from a stored voltage, versus appropriate upper or lower thresholds. The dependent signal value may be more directly representative of an applied synapse weighting factor.

In a further aspect, the refresh rate may be controlled based on characteristics of the stimulus signals themselves. For example, the signal-to-noise ratio (SNR), signal amplitude, or spectral characteristics of the signal such as bandwidth characteristics.

In the case of a system performing processing of audio signals, the signal characteristics may be based on:
a voice activity detection module (VAD) indicating the presence of speech in received audio;
a voice keyword detection module (VKD or KDW) indicating the presence of a keyword or wake-word in received audio;
a speaker identification or verification module indicating the identity or authorisation of a speaker of the received audio;
a command recognition module arranged to recognise commands present in speech in the received audio; or.
an acoustic environment determination module arranged to determine at least one indication of the user's environment

It will be understood that the processing required to provide some of the above-described signal characteristics may be output from the neuron array itself, e.g. the VAD or VKD modules.

The inference system may further comprise a processing scheduler arranged to control the processing of the neuron array. It will be understood that the scheduled processing may further be provided as an input to the refresh controller, e.g. so that weighting storage element refresh operations may be scheduled to be performed during idle time of the neuron array or idle time of particular layers or other defined subsets of neurons.

It will be understood that between refresh operations, leakage such as described above may result in a change in the effective value of the stored weight value. For example, referring back to FIGS. 2 and 3a and 3b, the voltage stored on the storage capacitor will vary, for example droop, which will result in a change in the value of the current through MOSFET 24 and thus the charge accumulated on output capacitor 32 in a given time period. As noted above the refresh rate may be controllably varied, in use, based on various different parameters.

In some embodiments the neuron circuit may be configured to compensate any the change in the weight value between the refresh periods. In some embodiments the neuron circuit 12 may comprise some compensation circuitry.

FIG. 5A illustrates one example of a neuron circuit, similar to that discussed with reference to FIG. 2, which includes compensation for a change in weight value.

FIG. 5A illustrates that the neuron circuit may include a matched reference, which is matched to the other weight storage element(s) of the neuron circuit. FIG. 5A thus illustrates that there may be a matched reference, i.e. a memory reference cell, comprising reference capacitor 26R and MOSFET 24R which may. as discussed above, be matched, e.g. in terms of size and fabrication process, to the storage capacitor(s) 26 and MOSFET(s) 24 of the synapse(s), and which may be may also be located in the same general circuit area of the neuron circuit so as to experience the same operating conditions. In use the matched reference may be set to a particular predefined weight value and may be refreshed by the weighting refresh circuit at the same time as the other weights. The current IREF from the matched reference should thus, immediately following a refresh operation, have a known predefined value corresponding to the predefined weight value. Over time leakage will cause the stored voltage to change and the reference current IREF to vary accordingly. Given the reference is matched to the weight storage components of the synapses, e.g. storage capacitor 26 and MOSFET 24, the reference current IREF should vary at largely the same rate as the other weight currents, and thus the reference current IREF can be used to determine and/or compensate for the amount of any change, e.g. droop, in the weight values.

Note that FIG. 5A illustrates a single synapse embodiment, with a corresponding matched element. In some examples, however, the neuron circuit may comprise a plurality of synapses and one matched reference may be provided as a reference for a plurality of synapses. In this case, the matched reference may be set to a value which is suitable for the expected range of weight values, e.g. around a midpoint of the possible weighting values, or set to a value which is likely to give the worst case maximum rate of change of reference current.

The current reference IREF from the matched reference, e.g. through MOSFET 24R, may be received by compensation circuitry 52 for applying a compensation for the change in weight values over time. The compensation may, in effect, be a gain applied to compensate for the change in reference current. Additionally or alternatively, an error detector 54 may be arranged to determine the extent of error in reference current IREF, i.e. the extent of variation of the reference current IREF from its nominal value, and in some implementations the error detector 54 may be configured to trigger a weighting refresh operation if the detected error exceeds a certain amount. Thus the matched reference and error detector could provide the functionality of the replica cell as discussed with reference to FIG. 4, but in addition the matched reference may be used for compensation which may be applied between refresh operations.

The compensation could be applied in a number of different ways. As discussed above with reference to FIG. 2, during a computation phase, the weight current through each synapse MOSFET 24 may be modulated, e.g. by a suitable PWM signal, to accumulate charge on output capacitor 32. This accumulated charge may be processed according to a defined non-linear function 33 and converted to a suitable output, e.g. a digital signal, by converter 34, although in some embodiments the non-linear function 33 may be applied to the output signal after conversion, e.g. as downstream processing applied to a digital output. In some embodiments the conversion by converter 34 may take place during a read-out phase which is separate to the computation phase.

In some examples the compensation could be applied to a digital output signal produced by converter 34. For example the compensation circuitry 52 could derive a digital gain value to be applied to a digital gain element 56. There are various ways such a digital gain value could be applied, for instance the reference current IREF could be converted to a digital current value and the value input to a suitable look-up table to derive a gain value that varies inversely with the reference current IREF. The error detector 54 could compare the digital current value, or the correspond digital gain value, to a suitable threshold and trigger a weighting refresh operation if the threshold is exceeded.

In some embodiments the compensation could be applied as a gain to the data input, for instance by varying the conversion gain of converter 28. For example, converter 28 could generate a PWM signal with pulses for controlling switch 30 by comparing the input data value to a time-varying reference waveform, such as a sawtooth waveform, and in some embodiments the slope of the reference waveform may be varied based on the reference current IREF. The reference current IREF could be supplied as an input to a reference waveform generator, e.g. a suitable integrator that is reset at the end of each cycle period. In this way the slope of the reference waveform may depend on the value of the reference current and vary with changes in the reference current. If leakage causes the relevant weight currents to drop, this, in effect, results in the drop in the stored weight values. However, the duration of the pulses of the PWM signal due to the input data will also tend to increase, as the reference waveform will take longer to rise the level of the input data, so the resulting product of weight multiplied by data will remain substantially constant. In this example, the error detector may be arranged to monitor the slope of the reference waveform, for instance by determining whether the reference waveform has reached a defined threshold level within a defined count period. If not, this may indicate that the reference current has dropped low enough to trigger a refresh operation.

It will thus be understood that whilst FIG. 5A illustrates the compensation circuitry 52 as a distinct module for clarity, in some embodiments at least part of the compensation circuitry 52 may form part of other modules of the neuron circuit.

In some examples the compensation could be applied as a gain to summation provided by the output capacitor 32. For instance the value of the capacitance of the output capacitor 32 may be selectively variable in use, e.g. by controlled switching of capacitances in parallel. The reference current IREF could be converted to a digital current value and used to control switching of the capacitances. The error detector 54 could compare the digital current value to a suitable threshold and trigger a weighting refresh operation if the threshold is exceeded.

In some examples the compensation could be applied as a gain to non-linear function 33, for instance by varying the slope of the non-linear function, whether such non-linear function is applied to an analog signal prior or digital signal.

In some examples the compensation could be applied as a conversion gain of converter 34, e.g. a conversion gain of an ADC of converter 34.

As noted above, in some implementations the neuron circuit 12 may be operable in at least two phases, a computation phase and a read-out phase. In the example of FIG. 5A, during the computation phase charge accumulates on output capacitor 32 based on the product of the data input and the weight value for each synapse. In the read-out phase, the switch 30 may be opened, to prevent any further charging of the output capacitor, and the value of charge accumulated on the output capacitor 12 may be determined by read-out circuitry, which may be converter 34 if the non-linear function 33 is applied downstream of converter 34.

In one implementation the converter 34 may be configured to discharge the output capacitor with a defined discharging current during the read-out phase and determine the time taken for the voltage on the output capacitor to reach a reference voltage Ref. The time taken to discharge the output capacitor 32 using the defined discharging current depends on the amount of charge accumulated during the computation phase, and hence the converter 34 output would effectively be a PWM signal indicative of the value stored on the output capacitor 32. In some embodiments the reference current IREF may be used to define the discharging current. If the weight current droop over time, the amount of charge accumulated on the output capacitor 32 for a given duration of PWM pulse will also drop, but as the reference current also drops at the same rate, the time taken to discharge a certain amount of charge from the output capacitor will increase to compensate. In this case the error detector may be arranged to monitor the reference current, for example the reference current compared to the minimum acceptable current defined by a current digital-to-analog converter (IDAC).

Other conversion implementations may be possible however. For instance in an alternative embodiment the output capacitor could be replaced with a current controlled oscillator (ICO) for generating an oscillation signal with a frequency that varies with input current. During a computation phase, a counter may be arranged to count the number of oscillation pulses in a count period corresponding to one or more PWM cycle periods. Over the course of a PWM cycle period, each weight current will contribute some current to the ICO for as long as the relevant switch 30 is closed, and the resultant count value effectively integrates the input current over the count period. In this instance during a read-out phase, the switch(es) 30 are opened and the reference current is applied to the ICO to generate a calibration count value. In some implementations the calibration count value could correspond to the number of oscillation pulses due the reference current IREF in a defined count period, and this value could be used to scale the count value generated in the computation phase. In other implementations the count value generated during the computation phase could be stored and the compared to the present count value during the read-out phase to determine the time taken for the count value during the read-out phase to reach the stored count value. Again this provides a PWM type output of the sum of the products of the input data and weight values from each synapse, but compensated for any variation in the weight currents. The compensation circuitry discussed above has used a matched reference as a dedicated source of a reference current. In some implementations however, where there are a plurality of synapses arranged with respective current weights to provide respective weight currents, the weight currents from a plurality of the weight current sources may be combined to provide a reference current.

FIG. 5B illustrates a further example of a neuron circuit 12 which operates in the same way as discussed above with respect to FIG. 2, but with a plurality of individual synapses. In the example of FIG. 5B there are two synapses that can contribute current to accumulation node 31, but there may be a greater number in some implementations. Thus a first storage capacitor 24 maintains a suitable weight voltage for MOSFET 24 to provide a first weight current and second storage capacitor 24A maintains a suitable weight voltage for MOSFET 24A to provide a second weight current. During a computation phase switches 30 and 30A are controlled independently by, e.g. PWM control signals, based on respective input data to so that the current at accumulation node 31 over the course of the PWM cycle corresponds to the sum of the product of the respective input data by the respective weight. FIG. 5B also illustrates the compensation circuitry 52 which, in this implementation, also performs the function of read-out circuitry for the neuron circuit 12, i.e. acts as converter 34. During the read-out phase switches 30 and 30A are opened the output capacitor 32 is discharged by a discharging current through MOSFET and comparator 60 determines the time taken for the voltage of the output capacitor 32 to discharge to a defined reference voltage Ref. As noted above the output Sout is thus a PWM type signal indicative of the charge accumulated on the output capacitor 32.

In this example the defined discharging current is generated from a plurality of the weight currents. In this example switches 62 and 64 may be closed during the read-out phase so as to combine both the first and second weight currents into a combined weight current signal, which is input to MOSFET 64 arranged as part of a current mirror with MOSFET 58 to provide the defined discharging current.

In this case time taken to discharge the output capacitor 32 will be proportional to the charge accumulated over the PWM cycle, i.e. the sum of the respective weight values and input data values, but will also depend on, and be inversely proportional to the sum of the weight values. In other words the PWM output will be proportional to Σ(DATA*Weight)/Σ(weight). This value will be insensitive to variations in the droop or other correlated variations in the weight currents.

It will be understood that the output value is thus inversely proportional to the sum of the weight values, which thus depends on the specific weight values. However the weight values are known and thus the sum of the weight values is also known and can be used as downstream scaling factor.

With reference to FIG. 6, an example of an inference system comprising an accuracy controller is illustrated, which operates to reduce the power consumption of the inference system by having an adjustable or dynamic accuracy.

The inference system comprises a neuron array of neuron circuits which are arranged to store weighting signal values for use in the neuron circuits using storage capacitors as weighting storage elements, as described above for example. The neuron array provides an array of decision outputs based on the product of weighting factors corresponding to the stored weighting signals and an array of stimulus signals or data inputs received by the inference system, e.g. audio signals, voice signals, optical signals, etc. The neuron circuits are arranged to perform a format conversion FMT of the decision outputs, for example by adjusting the duty cycle of a PWM output signal, as described above.

In a preferred aspect, a feature extraction operation is performed on the stimulus signals, with a format conversion FMT, e.g. PWM, performed on the feature extracted version of the data to provide the inputs SD to the neuron array.

The neuron array is configured that the weighting storage elements may be refreshed using appropriate refresh circuits as described above. Such a refresh may be coordinated using a refresh sequencer as described with reference to FIG. 4.

To allow for adjustment of the power consumption of the inference system, the accuracy of the inference system, may be adjusted as required. Such adjustment of the system accuracy may be controlled by the accuracy controller as shown in FIG. 5. This may switch the inference system between a low-accuracy mode of operation, having a first accuracy level; and a high-accuracy mode of operation, having a second accuracy level, the first accuracy level lower than the second accuracy level.

The inference system may comprise a plurality of subsets of neurons and the accuracy level of one subset may be adjusted to be different to another subset in at least one of the low-accuracy mode or the high-accuracy mode. This may allow the power versus performance trade-off of each layer to be adjusted optimally.

In one aspect, the accuracy controller is configured to adjust the accuracy of the system by variation of the operation of the FMT conversion block of the input signal. For example, a PWM conversion block may compare its input signal to a digitally-generated stepped ramp waveform. The resolution of this ramp may be reduced, thus allowing fewer steps in a conversion cycle but with poorer output resolution. Also the bias current for some elements may be reduced. For example, the conversion block may comprise a comparator whose bias current may be reduced as a slower response time and a worse accuracy may be permissible.

In another aspect, the accuracy controller is configured to adjust the accuracy of the output neurons of a neuron by variation of operation of the FMT converter blocks of the array, for example reducing the resolution in a similar way to the input converter FMT blocks.

In another aspect, the accuracy controller is configured to adjust the accuracy of the non-linear activation function block by varying a transfer function resolution or bias current for example.

By adjusting the resolution or quantisation of these blocks, accordingly the power consumption related to maintaining a relatively high resolution of data may be reduced, albeit with a corresponding reduction in accuracy. Providing for reduced quantisation of processed data may result in signification reductions in power consumption for inference systems which are relatively “data-heavy”, e.g. convolutional neural networks.

In a further aspect, the accuracy controller may adjust an accuracy mode output, which may be used as an input for the system of adjusting the memory refresh rate as described above with respect to FIG. 4.

The accuracy controller may control the variation of the system level accuracy based on one or more of a variety of factors.

In another aspect, the accuracy level may be controlled based on a system mode setting, which may include one or more of the following:
A power mode;
A POR mode; or
A user input.

As an example, if the system is used in a portable device, and it is detected that the device is currently operating using a mains power supply or while in the process of recharging a battery from an external power supply, then the accuracy level may be set relatively high due to the reduced emphasis on device power consumption. Conversely, if the system is used in a device which is operating on battery power, and/or if the device is set in a power conservation or idle mode, then the accuracy level may be set relatively low to provide reduced power consumption. A controller of a device may define a power mode in which the current taken by the inference system must be below a maximum value: the accuracy controller may receive an indication of the supply current it is consuming and adjust the accuracy accordingly to reduce power consumption.

As a second example, when the device is first turned on a power-on-reset (POR) function may directly (or indirectly via another system control or applications processor) indicate this to the Accuracy Controller, prompting it to initialise to a low-accuracy mode until it receives some indication from other inputs that a higher accuracy is required.

As a further example, if the device is in an idle mode not receiving user input, the accuracy level may be relatively low. Conversely, if a user input is received, e.g. via mechanical input or any other detected user interaction such as a voice command or similar, or if the device determines that a user might be about to interact with the device, e.g. using a proximity detect or image analysis of an approaching user, then the accuracy level may be increased. It will be understood that the processing required to provide some of the above-described user approach or proximity analysis may be performed by the neuron array itself.

In a further aspect, the accuracy level may be controlled based on characteristics of the stimulus signals themselves. For example, the signal-to-noise ratio (SNR), signal amplitude, or spectral characteristics of the signal such as bandwidth characteristics.

In the case of a system performing processing of audio signals, the signal characteristics may be based on:
a voice activity detection module (VAD) indicating the presence of speech in received audio;
a voice keyword detection module (VKD or KDW) indicating the presence of a keyword or wake-word in received audio;
a speaker identification or verification module indicating the identity or authorisation of a speaker of the received audio;
a command recognition module arranged to recognise commands present in speech in the received audio; or
an acoustic environment determination module arranged to determine at least one indication of the user's environment

It will be understood that the processing required to provide some of the above-described signal characteristics may be output from the neuron array itself, e.g. the VAD or VKD modules.

FIG. 7 illustrates an example of a neuron array which may be provided as part of the inference system of FIG. 1, in particular as relating to weighting storage element refreshing operations.

The array comprises a plurality of neuron blocks, each providing an output Dout based on one or more input signals Di. A portion of the input signals Din may be received from upstream processing circuitry, while a further portion of the input signals Di may be provided as the outputs of other neurons of the array. For a neuron j, each input signal Di is subjected to a multiplication by a respective weighting factor or weight Wij. By analogy with biological neurons, the multiplication circuitry may be termed a synapse and the resulting product comprises an output of the synapse.

The outputs of the synapses in each neuron may be summed in the summing block Σ, with a non-linearity f(x) applied to the sum. The resulting signal may require format conversion FMT, e.g. from a current to a voltage, or into a pulse-width-modulated signal, so as to provide the neuron j output signal Doutj in an appropriate format to serve as the input of another neuron or to provide an output in a desired format from the whole array.

As explained above, in an analog neuron array, to save power of continual memory data access and power and die area involved in continual digital-analog conversion of each weight, the weighting factor is stored as a corresponding analog signal on a weighting storage element, for instance as a stored voltage on a capacitor.

As illustrated in FIGS. 2 and 3a and 3b, each synapse may be connectable to one or more common signal lines SW via one or more switches 44 or 44a/44b for refreshing the weighting storage element. The switch(es) may be controlled by the output of a digital decoder which receives an input signal AS representing the address of the particular synapse. When selected, the relevant switch connects the weighting storage element to the signal line SW, which may be driven by an analog weighting signal. As illustrated, this analog signal may be a voltage, and may be the output of an upstream voltage-output analog-to-digital converter and will serve to charge the storage capacitor up to a required voltage. This voltage may be applied to a multiplier of the form of an analog voltage multiplier. Alternatively (not illustrated in FIG. 7, but discussed with respect to FIGS. 2 and 3) the analog signal may be defined as a current. For example, the synapse may comprise a current mirror arrangement for instance whose controlling voltage is stored as the weighting signal on the storage capacitor and which mirror delivers an output current into a current-input multiplier, for example a multiplier in which the weighting current is gated by a pulse-width modulated data signal.

Thus a voltage corresponding to a desired weighting factor may be initially stored on the storage element. However a practical capacitor and switch (for instance a MOS transistor switch) will suffer from leakage currents, for instance sub-threshold drain-source current or junction leakage form source or drain for a MOS transistor switch. Thus the synapse will require to be re-selected to refresh periodically in order to ensure that the stored memory value remains accurate.

Other neurons in the array may be connected to other lines output from the decoder and to the common signal line SW as well as respective data inputs, but these connections are omitted from FIG. 7 for reasons of clarity. In some embodiments the same storage element may provide a voltage to define equal or scaled (by respective different sensitivity multiplier circuits) weighting factors of multiple synapses, not necessarily in the same neuron, or a plurality of storage elements may be simultaneously selected, again to result in deliberately defining equal or scaled weighting factors. This may be advantageous for some neural network structures, for instance where similar operations are performed in parallel by different neurons or sets of neurons.

The inference systems as described above may be provided as an integrated circuit device for use in an electronic system.

With reference to FIG. 8, it will be understood that any of the configurations of inference system described above may be provided as a component 102 of an electronic device 100, e.g. a battery-powered personal audio device such as a mobile phone, a tablet computer, a personal music player, etc. The electronic device 100 may also be provided as part of a “smart device”, such as a voice assistant device, or an electronic device having embedded voice-processing functionality, e.g. smart televisions, home music players, etc. The electronic device 100 may also be provided as an accessory device, for example a digital wired or wireless headset, to co-operate with such devices. The device 100 comprises data inputs 104 to receive input signals from the device or from various sensors provided on the device, the device comprising at least one device output 106 to provide output to a user via audio or visual or haptic output devices.

The inference system 102 may be coupled with an off-chip memory 108 provided in the device 100, for example for the retrieval of memory weights or to provide parameters (e.g. thresholds) for the operation of the Refresh or Accuracy Controllers. The operation of the inference system 110 may be controlled by device controller 110, e.g. an applications processor (AP) or a central processing unit (CPU) of the device.

The use of an inference system as described above provides a system for the implementation of deep learning and neural nets systems having reduced power consumption.

While the above embodiments are preferably implemented for an inference system on an edge device, it will be understood that the invention may also apply to inference systems for use in centralised servers or cloud-connected networks.

The invention is not limited to the embodiments or claims described herein, and may be modified or adapted without departing from the scope of the present invention.

1. An inference system comprising:
at least one neuron circuit arranged to receive at least one data input and at least one weighting signal, the neuron circuit arranged to output a signal based on at least the at least one data input and the at least one weighting signal; and
at least one weighting refresh circuit arranged to retrieve at least one weighting data value from a memory and to output at least one weighting signal for the at least one neuron circuit,
wherein the weighting refresh circuit is configured to repeatedly retrieve the at least one weighting data value from the memory at a refresh rate, wherein the refresh rate is dynamic or adjustable.

2.-6. (canceled)

7. The inference system of claim 1, wherein the refresh rate is adjustable based on one or more of:
a voltage or current level of a power supply associated with the inference system;
a power supply source of a device incorporating the inference system;
a power mode of a device incorporating the inference system;
operational parameters of the inference system; and
operational temperature of the inference system.

8. (canceled)

9. The inference system of claim 1, wherein the refresh rate is adjusted based on one or more of the following:
a voice activity detection module (VAD) indicating the presence of speech in received audio;
a voice keyword detection module (VKD) indicating the presence of a keyword or wake-word in received audio;
a speaker identification or verification module indicating the identity or authorisation of a speaker of the received audio;
a command recognition module arranged to recognise commands present in speech in the received audio;
an audio quality metrics module arranged to determine at least one indication of the signal quality of the received audio, e.g., signal-to-noise level, signal amplitude, bandwidth metrics, etc.;
an acoustic environment determination module arranged to determine at least one indication of the user's environment; and
a signal indicative of a user interaction with an electronic device incorporating the inference system.

10. (canceled)

11. The inference system of claim 1 The inference system of any one of claims 1-10, wherein the refresh rate is adjusted based on the output of a memory reference cell.

12. The inference system of claim 11, wherein the inference system comprises at least one memory reference cell, the memory reference cell arranged to receive a weighting signal from a weighting circuit, the weighting signal stored in the memory reference cell,
wherein the memory reference cell is configured to monitor the level of the stored weighting signal, and wherein the memory reference cell is arranged to trigger a refresh of the weighting storage elements for at least a portion of the inference system if the monitored level passes a threshold value.

13. The inference system of claim 12, wherein the allowable threshold level of the memory reference cell is adjusted based on a desired accuracy level of the inference system.

14. The inference system of claim 1, wherein a refresh operation may be triggered based on a calculation cycle, or as an on-demand refreshing of system memory.

15. The inference system of claim 1, wherein the inference system is operable to perform a calibration operation, wherein the data inputs for the at least one neuron circuit are set to known input values and the output of the at least one neuron circuit is compared to an expected output value, and wherein if the output is different to the expected output value a weighting storage element refresh with a modified weighting signal value is performed.

16. (canceled)

17. The inference system of claim 1, wherein the inference system comprises a plurality of weighting storage elements, wherein the different weighting storage elements are refreshed at different refresh rates.

18. The inference system of claim 1, wherein the inference system comprises a plurality of neuron circuits having at least one associated weighting refresh element, wherein the plurality of neuron circuits are arranged in sets comprising one or more neuron circuits and each set of each neuron circuits is provided with a separate weighting refresh circuit.

19.-20. (canceled)

21. The inference system of claim 1, wherein the inference system is configured to generate an output based on a received input signal, wherein the refresh rate is adjustable based on the characteristics of the received input signal, for example the signal-to-noise ratio of the received input signal; the amplitude level of the received input signal; or any other suitable quality metric of the received input signal.

22. (canceled)

23. The inference system of claim 1, wherein the refresh rate is adjustable based on the magnitude of the weighting factor corresponding to the weighting storage element to be refreshed.

24. (canceled)

25. The inference system of claim 1, wherein the weighting refresh circuit comprises a digital-to-analog converter (DAC) which is configured to receive a weighting data value from a digital memory storage, and to convert the digital weighting data value to an analog weighting current output of the weighting refresh circuit.

26. The inference system of claim 25, wherein the DAC is selectively coupled with a plurality of weighting storage elements, wherein the DAC is configured to output respective analog weighting currents which may be used to provide respective weighting signals to refresh each of the plurality of weighting storage elements, wherein the refresh of the respective weighting storage elements of the plurality by respective weighting signals is be performed at different times by the same DAC.

27. (canceled)

28. The inference system of claim 1, wherein the at least one neuron circuit comprises compensation circuitry for compensating for any variation in the at least one weighting signal between refresh operations.

29. (canceled)

30. A neuron circuit for inference, the circuit comprising:
an input to receive a data signal representative of a data input for the neuron circuit;
a controlled current source arranged to output onto an accumulation node a weighting current dependent on the voltage on a control node, via a first switch controlled by the data signal
a weighting storage element connected to the control node
a second switch periodically closed to connect the weighting storage element to a weighting signal source and opened to isolate the weighting storage element.

31.-34. (canceled)

35. The neuron circuit of claim 30 comprising compensation circuitry for compensating for any change in the value of the weighting current.

36. The neuron circuit of claim 35 wherein the compensation circuitry is configured to receive a reference current and, based on the reference current, to control at least one of:
a conversion gain of a controller for controlling the first switch based on the data signal;
a value of capacitance coupled to the accumulation node;
a conversion gain of a converter for generating an output signal based on current supplied to the accumulation node; and
a digital gain applied to a digital output signal from a converter for generating an output signal based on current supplied to the accumulation node.

37. The neuron circuit of claim 36 wherein the reference current is received from a matched reference cell comprising a reference controlled current source a weighting storage element.

38. The neuron circuit of claim 36 wherein said controlled current source is one of a plurality of controlled current sources, each controlled current source for outputting a respective weighting current onto the accumulation node, via respective first switches controlled by respective data signal, each controlled current source having a respective weighting storage element connected to the respective control node; wherein the reference current is formed from a combination of said weighting currents.

39. An inference system comprising:
at least one neuron circuit comprising at least one synapse, said synapse arranged to:
receive a weighting signal corresponding to a synapse weighting factor;
receive a data input signal; and
output a synapse output signal based on the product of the data input signal and the synapse weighting factor;
and wherein the inference system further comprises:
at least one accuracy control input, to adjust an accuracy level of the synapse weighted output.

40.-44. (canceled)

45. The inference system of claim 39, wherein the accuracy level is adjusted by adjustment of the operation of data conversion or activation function performed in neurons of the inference system.

46.-49. (canceled)
